(19) United States
(12) Patent Application Publication
(10) Pub. No.: US 2008/0102765 A1
(43) Pub. Date: May 1, 2008

(54) Wireless Adaptor Power Control

(75) Inventors: Ronald A. Louks, Durham, NC (US); Nadi Sakir Findikli, Cary, NC (US); Gerard J. Hayes, Wake Forest, NC (US); Rodney Owen Williams, Cary, NC (US)

Correspondence Address: COATS & BENNETT/SONY ERICSSON, 1400 CRESCENT GREEN, SUITE 300, CARY, NC, 27511, US

(73) Assignee: Sony Ericsson Mobile Communications AB, Lund (SE)

(21) Appl. No.: 11/675,775

(22) Filed: Feb. 16, 2007

Related U.S. Application Data
(60) Provisional application No. 60/863,385, filed on Oct. 29, 2006.

(51) Int. Cl. H04B 1/38

(52) U.S. Cl. 455/90.1

(57) ABSTRACT

A wireless adaptor for a portable electronic device enables the electronic device to communicate over wireless networks with remote devices. The wireless adapter includes a communication circuit configured to communicate data with a remote device over a wireless network. The wireless adaptor may further include a battery and a power control circuit operatively connected to the battery and the communication circuit. The power control circuit is configured to provide at least supplemental power from the battery to the communication circuit.

### RELATED APPLICATIONS

This application claims priority from U.S. Provisional Patent Application 60/863,385 filed Oct. 29, 2006, which is incorporated herein by reference.

### BACKGROUND

The present invention relates generally to wireless adaptors, and more particularly to power control of wireless adaptors.

Communication devices typically include a USB port that functions as a reliable and simple interface for an external accessory device. One such accessory device is a wireless adaptor, such as a wireless modem, that enables the communication device to communicate with a wireless network.

It is desirable to use the USB interface as the only interface between the communication device and the wireless adaptor. However, this presents a number of design challenges. The most serious design challenge is the general trade-off between the amount of power available through the USB interface and the amount of power required to operate the wireless communication circuits in the wireless adaptor. That is, the average and instantaneous power limits of the USB interface may interfere with or prevent the full operation of a USB-connected wireless adaptor. Other types of host interfaces for wireless adaptors also may constrain or limit the instantaneous or average power provided to the adaptor, and therefore interfere with or prevent adaptor operation.

### SUMMARY

The present invention overcomes the power limitations of conventional wireless adaptors connected to a host device. An exemplary wireless adaptor includes a communication circuit and a power control circuit. The communication circuit communicates with a remote device over a wireless network. The power control circuit provides power to the communication circuit. According to one embodiment, the power control circuit further provides at least supplemental power from a battery and/or an external secondary power source to the communication circuit. According to another embodiment, the power control circuit determines a maximum permissible current draw for the host interface and adjusts one or more communication parameters based on the maximum permissible current draw. In still another embodiment, the wireless adaptor communicates with the user to inform the user of the capabilities of the wireless adaptor based in the available current draw. The wireless adaptor may further suggest that the user connect the wireless adaptor to an alternate port in the host device to improve the operation of the wireless adaptor.

### BRIEF DESCRIPTION OF THE DRAWINGS

FIG. 1 shows an exemplary network environment for the present invention.

FIG. 2 shows one exemplary wireless adaptor.

FIG. 3 shows an exemplary power control circuit according to one embodiment of the present invention.

FIG. 4A shows exemplary power connections during a charging phase for the power control circuit of FIG. 3.

FIG. 4B shows exemplary power connections during one transmission phase for the power control circuit of FIG. 3.

FIG. 4C shows exemplary power connections during another transmission phase for the power control circuit of FIG. 3.

FIG. 4D shows exemplary power connections during another transmission phase for the power control circuit of FIG. 3.

FIG. 5 shows an exemplary power control circuit according to another embodiment of the present invention.

FIG. 6 shows an exemplary power control circuit according to another embodiment of the present invention.

FIG. 7 shows an exemplary power control circuit according to another embodiment of the present invention.

FIG. 8 shows an exemplary power control circuit according to another embodiment of the present invention.

FIG. 9 shows an exemplary power control circuit according to another embodiment of the present invention.

### DETAILED DESCRIPTION

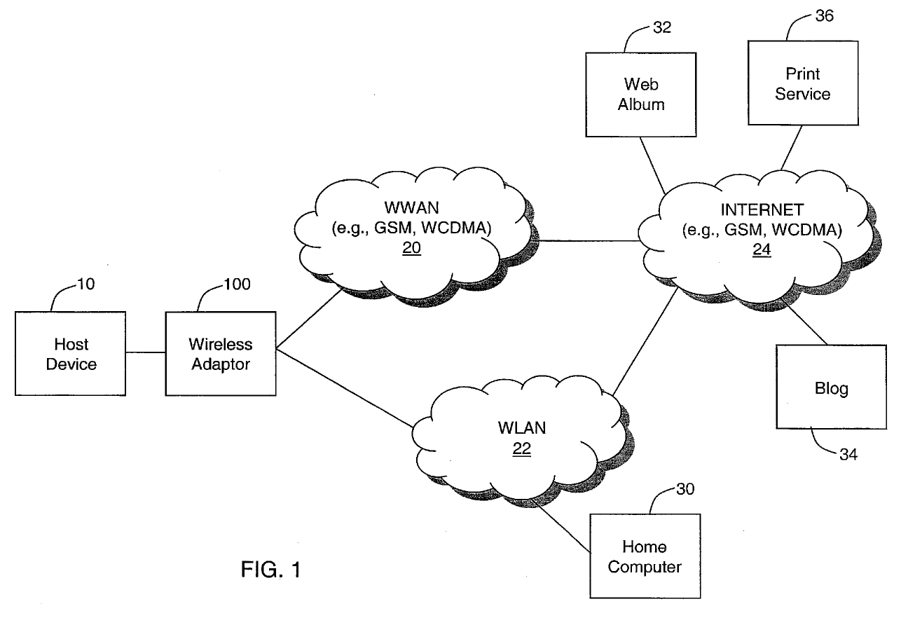

The present invention provides a method for providing adequate power to a wireless adaptor 100 used to wirelessly connect a host device 10 to a local or wide-area network to connect the host device 10 to remote devices or services, such as a home computer 30, web album 32, blog 34, or print service 36 over a network. The host device 10 may comprise any portable electronic device, including but not limited to a laptop computer, digital still camera, or digital video camera. For example, the host device 10 may comprise a digital camera that transfers images to a remote device or service using the wireless adaptor 100. Exemplary processes for transferring images from a digital camera over a wireless network are described in co-pending Application Ser. No. 60/863,382 filed 29 Oct. 2006, which is incorporated herein by reference. The wireless adapter 100 comprises an accessory device that connects to a port in the host device 10 and provides wireless access capability to the host device 10 that otherwise lacks inherent wireless networking capabilities. FIG. 1 shows an exemplary networking environment in which the present invention may be implemented. Wireless adapter 100 connects to host device 10 and provides remote access capability to the host device 10. As will be described in greater detail below, the wireless adapter 100 can connect to a wireless wide area network (WWAN) 20 or a wireless local area network (WLAN) 22. The WWAN 20 and/or WLAN 22 provide connection to the Internet 24. The WLAN 22 may comprise a home network, such as a local area network (LAN) connected to a home wireless adaptor for wireless communication with the wireless adaptor 100. Home computer 32 connects to the WLAN 22. Various services, such as a Web album 32, blog 34, and print service 36, for example, may reside on servers connected to the Internet 24.

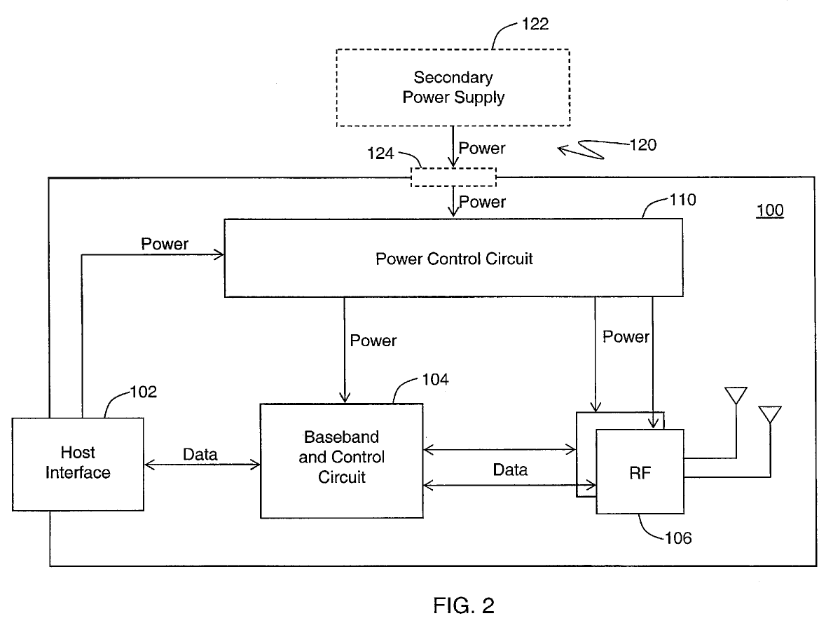

FIG. 2 shows an exemplary wireless adaptor 100. Wireless adaptor 100 includes host interface 102, baseband and control circuit 104, one or more wireless interfaces 106, and power control circuit 110. Host interface 102 transfers data between the host device 10 and the baseband and control circuit 104. Host interface 102 also provides power from the host device 10 to power control circuit 110. Baseband and control circuit 104 processes the data and provides the processed data to wireless interface(s) 106 for transmission to wireless network 20, 22. For simplicity, baseband circuit 104 and wireless interfaces 106 are collectively referred to herein as communication circuits. Power control circuit 110 provides power to the communication circuits to achieve a desired wireless communication performance.

Under certain radio conditions, wireless adaptor 100 cannot draw enough power through host interface 102 to achieve a desired wireless communication performance for all communication parameters, i.e., transmission data rate. For example, host interface 102 may only be able to provide approximately 5V at a current between 100 mA and 500 mA. Such power levels are generally insufficient for all wireless operations, such as 2 G and/or 3 G operations. For example, 2 G communications may require a current draw exceeding 2.5 A during a TDMA transmission burst.

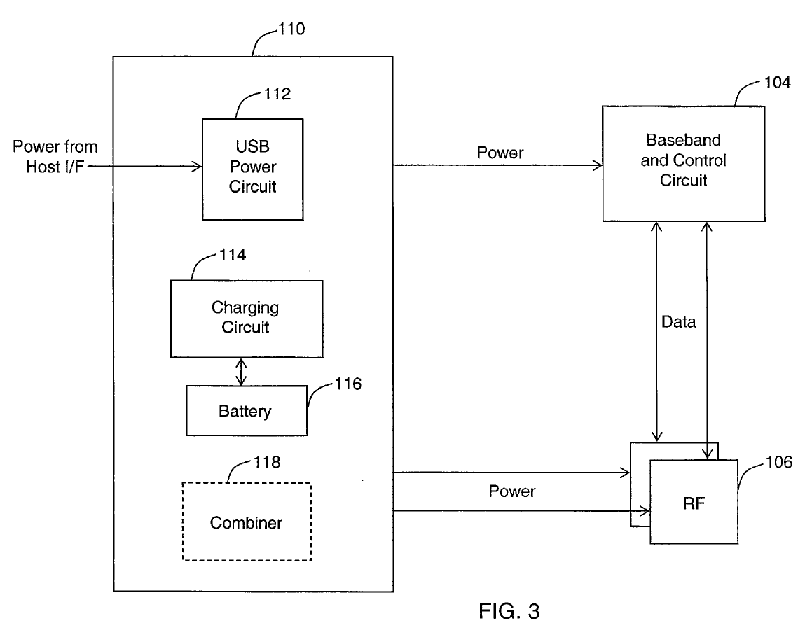

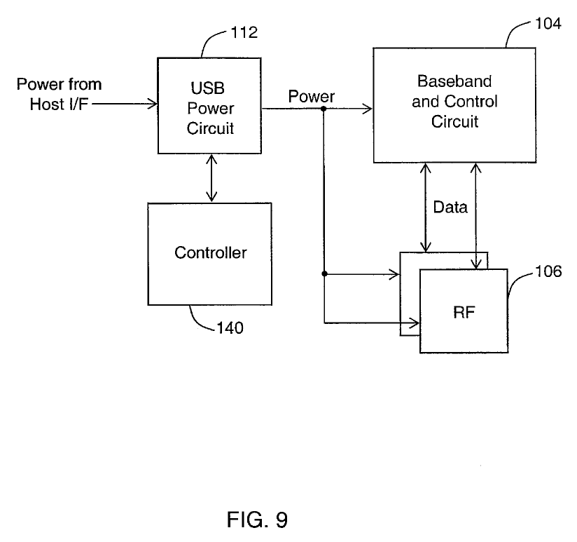

One embodiment of the present invention solves this problem by modifying power control circuit 110 to include a battery that is used to provide at least supplemental power to the communication circuits. While the wireless adaptor 100 is not communicating with a remote device, power control circuit 110 may use the power received through host interface 102 to charge the battery. For this embodiment, power control circuit 110 may draw high current pulses through the host interface 102 to more quickly charge the battery while avoiding being disconnected from the host device 10 for violating limits on maximum continuous current draw. Alternatively, power control circuit 110 may use power provided by a secondary source to charge the battery. The power control circuit 110 of the present invention may also use power from the external secondary source to separately provide at least supplement power to the communication circuits. FIGS. 3-8 illustrate exemplary power control circuits 110 that provide supplemental power according to different embodiments of the present invention. In another embodiment, the baseband and control circuit 104 of FIG. 2 may be modified to control parameters of the communication circuits in consideration of the power constraints of the host interface 102. In still another embodiment, shown in FIG. 9, the power control circuit 110 may perform a search algorithm to determine the actual maximum power available through host interface 102. For simplicity, the following assumes that host interface 102 is a USB interface. However, it will be appreciated that the present invention is not limited to USB interfaces.

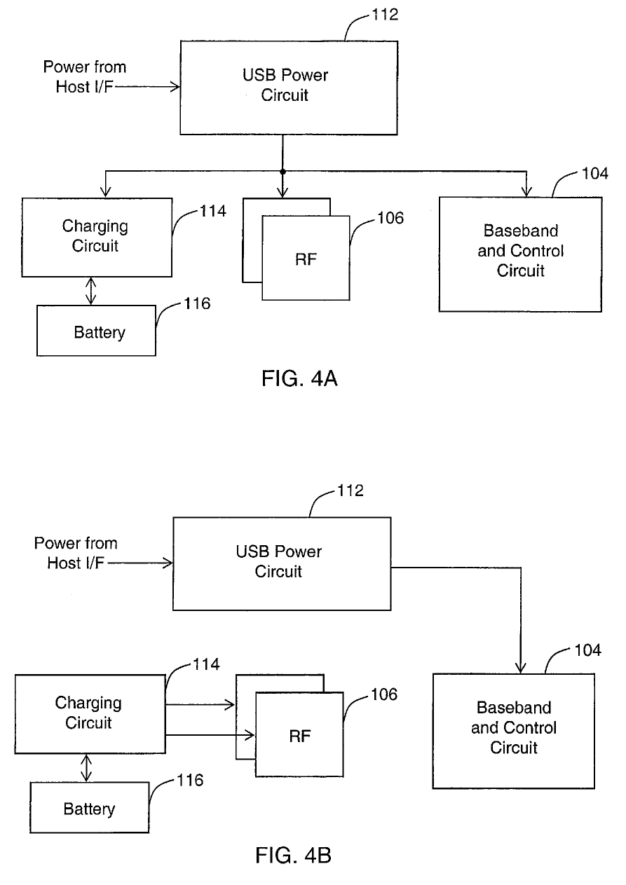

FIG. 3 shows an embodiment where the power control circuit 110 comprises a USB power circuit 112, a charging circuit 114, a battery 116, and an optional combiner 118. For this embodiment, USB power circuit 112 controls the power received through USB interface 102 to provide power to baseband circuit 104, wireless interface(s) 106, and charging circuit 114 when wireless adaptor 100 is not transmitting or receiving any data, as shown in FIG. 4A. This enables charging circuit 114 to charge battery 116 using the power output from USB power circuit 112.

In one embodiment, battery 116 may be charged with the power output by USB power circuit 112 at the current level permitted by the USB interface 102. However, because the allowed current level is typically low, e.g., between 100 mA and 500 mA, it may take a significant amount of time to charge the battery 116 in this manner. To speed up the charging operations, the present invention may implement a pulse charging process. A USB interface 102 typically allows high current levels for brief periods, but will not allow sustained high level currents. If the high current level is sustained for a duration that exceeds an alarm threshold, the USB power circuit 112 signals an alarm. Charging circuit 114 may avoid the alarm while significantly decreasing the total charging time by drawing high current pulsed through the host interface 102, where the pulses have a duration less than the alarm threshold.

When wireless adaptor 100 wirelessly communicates with a remote device by, for example transmitting data at a desired data rate, the power control circuit 110 stops the charging operations and interconnects the USB power circuit 112, charging circuit 114, and optionally combiner 118. FIGS. 4B-4D show different power connection scenarios that provide the requisite power to the communication circuits 104, 106 during wireless communication operations. While not explicitly shown, it will be appreciated that one or more switching circuits may be used to selectively provide the power connections during charging and communication operations.

In the embodiment shown in FIG. 4B, USB power circuit 112 provides the power to baseband circuit 104 responsive to a control signal (not shown), while charging circuit 114 provides the power from battery 116 to wireless interface(s) 106. Thus, this embodiment isolates the higher power operations of the wireless interface(s) 106 from the power-limited USB connection.

In the embodiment shown in FIG. 4C, USB power circuit 112 provides USB power to baseband circuit 104. Combiner 118 combines the power from USB power circuit 112 with the battery power from charging circuit 114. The combiner 118 provides the combined power to wireless interface(s) 106. Thus, this embodiment uses the power-limited USB connection to provide power to the lower power baseband circuits 104, while simultaneously using the battery power to supplement any extra USB power provided to the wireless interface(s) 106.

In the embodiment shown in FIG. 4D, combiner 118 combines the power output by USB power circuit 112 and the power from battery 116 provided by charging circuit 114. The combiner 118 provides the combined power to both the baseband circuit 104 and the wireless interface(s) 106. Thus, this embodiment provides combined power to the communication circuits to ensure that neither the baseband circuit 104 nor the wireless interface(s) 106 are power limited by the USB connection.

The above describes various embodiments of the power control circuit 110 that use USB power circuit 112 to directly or indirectly provide all required power. According to another exemplary embodiment, power control circuit 110 may provide supplemental power using a secondary power source 120 comprising an external power supply 122 connected to power control circuit 110 via a connector 124 (see FIG. 2). Connector 124 may comprise any available connector that provides power, including but not limited to a power connector, a USB connector, and a system connector. Secondary power source 120 may provide power from any external source. For example, secondary power source 120 may provide power from an AC power outlet via a stand-alone mobile device charger or a docking station charger. Alternatively, secondary power source 120 may provide power from a host device (10), such as a laptop, through any type of system connector that provides power, including but not limited to a USB interface, an Ethernet interface, and a peripheral interface, such as a headset interface or a keyboard interface.

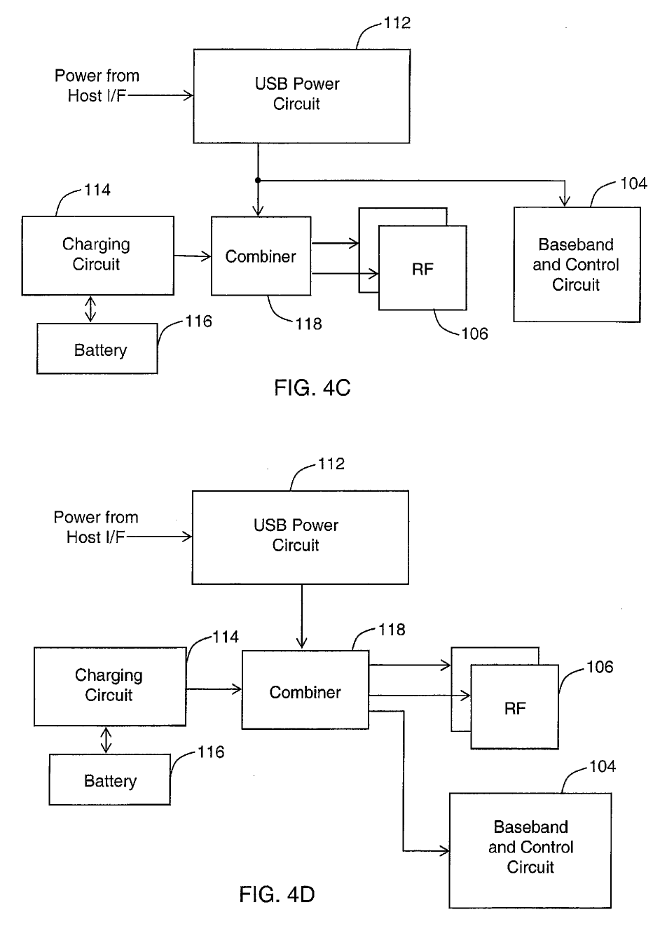

FIGS. 5-8 illustrate exemplary power control circuits 110 that provide at least supplemental power from a secondary power source 120. FIG. 5 shows an embodiment where power control circuit 110 includes USB power circuit 112 and a secondary power circuit 126. Because baseband circuit 104 typically requires less power than wireless interface(s) 106, the embodiment of FIG. 5 uses USB power circuit 112 to provide power received through the USB interface 102 to the baseband circuit 104, and uses the secondary power circuit 126 to provide the power from secondary power source 126 to the wireless interface(s) 106. Thus, this embodiment isolates the higher power operations of the wireless interface(s) 106 from the power limited USB connection.

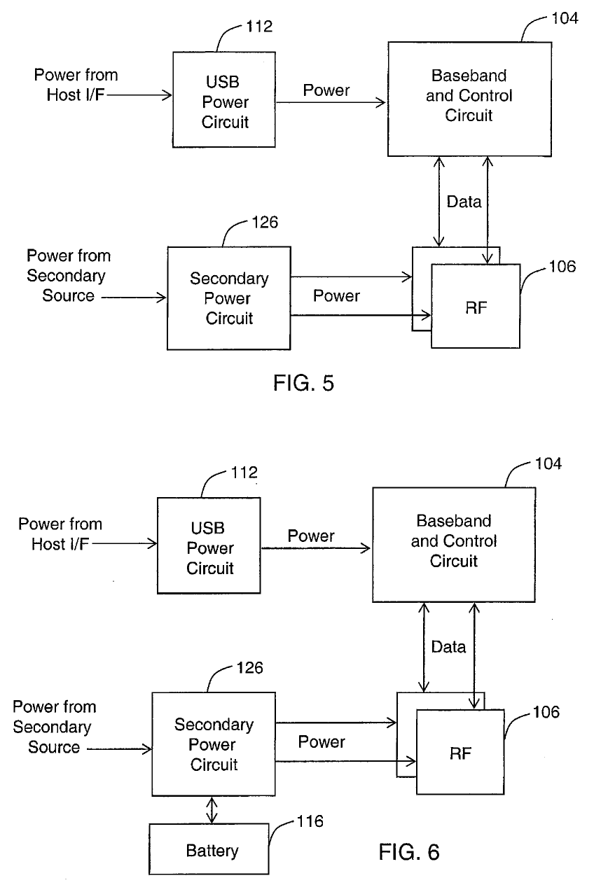

FIG. 6 shows an alternate embodiment where power control circuit 110 includes USB power circuit 112, secondary power circuit 126, and a battery 116. As with the embodiment shown in FIG. 5, the USB power circuit 112 of FIG. 6 provides power to the baseband circuit 104. Secondary power circuit 126 charges battery 116 using power from the secondary power source 120. When wireless interface(s) 106 need power to transmit/receive data, secondary power circuit 126 provides power from battery 116 to wireless interface(s) 106. As such, the embodiment of FIG. 6 enables wireless adaptor 100 to operate even when disconnected from the secondary power source 120.

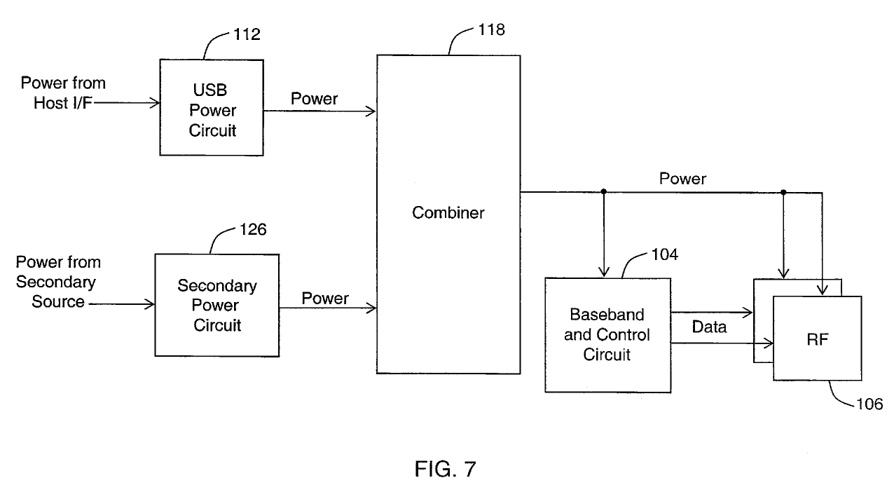

According to another embodiment shown in FIG. 7, the power control circuit 110 includes USB power circuit 112, secondary power circuit 126, and a power combiner 118. Secondary power circuit 126 supplements the power provided by USB power circuit 112 so that when combined in combiner 118, the power provided to the communication circuits 104, 106 is sufficient to achieve a desired wireless communication performance.

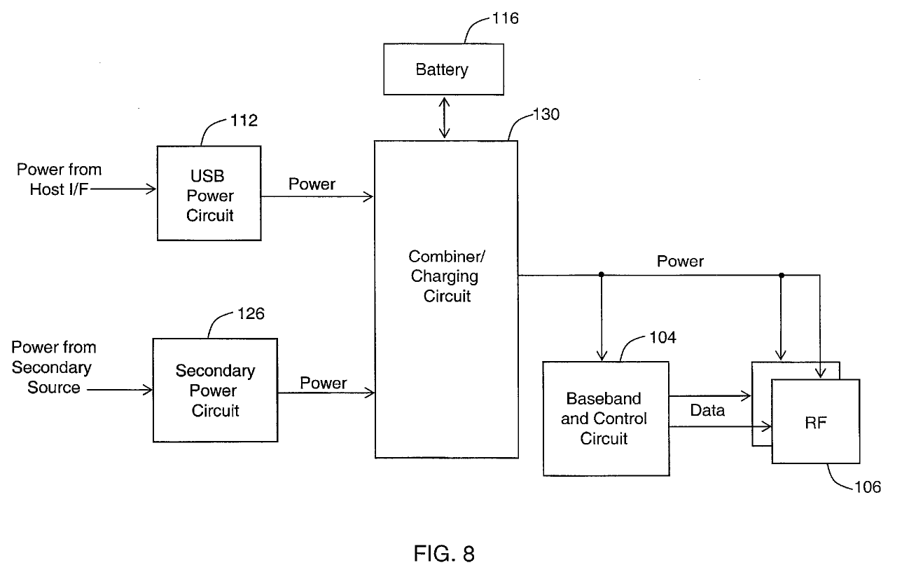

The power control circuit 110 shown in FIG. 8 includes USB power circuit 112, secondary power circuit 126, a power combiner/charging circuit 130, and a battery 116. Based on the control signal, USB power circuit 112 and secondary power circuit 126 provide enough power to enable combiner/charging circuit 130 to charge the battery 116. When the communication circuits 104, 106 require power for wireless communications, combiner/charging circuit 130 draws power from battery 116 to provide the power required to achieve a desired performance.

In addition to the above described power supplementation, the present invention may alternatively or additionally control wireless communication parameters to reduce the power requirements, and therefore, to better utilize the power provided by power control circuit 110. For example, consider the scenario where the power control circuit 110 comprises a USB power circuit 112 and a controller 140, as shown in FIG. 9. The baseband and control circuit 110 may adjust one or more communication parameters, i.e., a transmission data rate in light of the power provided to USB power circuit 112 by USB interface 102.

The wireless adaptor 100 adjusts a communication parameter based on the maximum power believed to be available from the USB interface 102. The wireless adaptor 100 may determine the maximum available power according to any known means. Alternatively, the wireless adaptor 100 may use a search process according to the present invention to determine the maximum available power. One exemplary search process takes advantage of the fact that the current draw actually allowed by the host interface 102 may be more than the specified maximum current draw. The present invention uses a trial and error approach to determine how much current draw the host interface 102 will actually allow. More particularly, the controller 140 incrementally increases the maximum current consumption declaration used by USB power circuit 112 while monitoring the host device operating parameters. Nonvolatile storage (not shown) in wireless adaptor 100 stores the host device parameters and timestamps associated with the incremental current increases. When the wireless adaptor 100 exceeds the acceptable current draw, the host device 10 disconnects from the wireless adaptor 100. In this case, wireless adaptor 100 reconnects and controller 140 sets the last known allowed current declaration, identified by the most recent timestamp, as the maximum current draw.

Additionally or alternatively, the wireless adaptor 100 may interact with the user of host device 10 regarding maximum available current draw. For example, the host device 10 may have more than one port compatible with host interface 102. In this case, the controller 140 may determine communication parameters based on the maximum permissible current draw of the port currently connected to host interface 102. If the determined communication parameters are insufficient, wireless adaptor 100 may inform the user that the selected port will not provide the desired service. The controller 140 may further suggest connecting the host interface 102 to an alternate port to obtain a higher current draw. Further, after determining the maximum current draw and the corresponding operating parameters and/or wireless performance expectations, the controller 140 may inform the user of the operating parameters and/or the performance available at the selected port. Wireless adaptor 100 then operates within the determined operating parameters and/or performance limits.

The above describes multiple ways to optimize wireless communications provided by a wireless adaptor 100 connected to a host device 10. In some embodiments, the wireless adaptor 100 charges an embedded battery 116 using the available USB power, and uses the charged battery 116 to provide at least supplemental power to the communication circuits (104, 106) during wireless communications. In other embodiments, an external secondary power source 120 provides the supplemental power. In still other embodiments, the wireless adaptor 100 determines the maximum current available through the host interface and adjusts one or more communication parameters based on the maximum available current. In still another embodiment, the wireless adaptor communicates with the user to inform the user of the current capabilities of the wireless adaptor 100. In all of these embodiments, the wireless adaptor 100 of the present invention improves upon the wireless communication capabilities available from conventional wireless adaptors having conventional power control systems.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A wireless adaptor comprising:
a communication circuit configured to communicate data with a remote device over a wireless network;
a battery; and
a power control circuit operatively connected to the battery and the communication circuit, said power control circuit configured to provide at least supplemental power from the battery to the communication circuit.

2. The wireless adaptor of claim 1 further comprising a connector configured to receive power from a secondary power source.

3. The wireless adaptor of claim 2 wherein the secondary power source comprises a charger for a host device, and wherein the connector comprises a connector compatible with the charger.

4. The wireless adaptor of claim 2 wherein the secondary power source comprises a power source in a host device and wherein the connector comprises one of a USB interface, an Ethernet interface, and a peripheral interface.

5. The wireless adaptor of claim 2 wherein the secondary power source comprises a charger of a host device docking station, and wherein the connector comprises a power connector in the docking station.

6. The wireless adaptor of claim 2 wherein the secondary power source is configured to charge the battery.

7. The wireless adaptor of claim 2 further comprising a host interface configured to communicate data with a host device, and further configured to receive power from the host device.

8. The wireless adaptor of claim 7 wherein the power control circuit comprises:
an interface power circuit operatively connected to the host interface and configured to control the power received through the host interface to provide power to a baseband and control circuit in the communication circuit; and
a secondary power circuit operatively connected to the battery and one or more wireless interfaces in the communication circuit, wherein said secondary power circuit is configured to charge the battery with the power received through the connector, and further wherein the secondary power circuit is configured to provide power from the battery to the one or more wireless interfaces.

9. The wireless adaptor of claim 7 wherein the power control circuit comprises:
an interface power circuit operatively connected to the host interface and configured to control the power received through the host interface;
a secondary power circuit configured to control the power received through the connector;
a joint combiner and charging circuit operatively connected to the interface power circuit, the secondary power circuit, and the battery, said joint combiner and charging circuit configured to:
combine power output by the secondary power circuit with power output by the interface power circuit;
charge the battery with the combined power; and
provide power from the battery to the communication circuit.

10. The wireless adaptor of claim 1 wherein the power control circuit comprises:
an interface power circuit connected to the host interface and configured to control the power received through the host interface; and
a charging circuit connected to a rechargeable battery, wherein the charging circuit is configured to charge the battery using the power received through the interface power circuit.

11. The wireless adaptor of claim 10 wherein the communication circuit comprises a baseband and control circuit operatively connected to one or more wireless interfaces, said one or more wireless interfaces configured to communicate data with a remote device over a wireless network.

12. The wireless adaptor of claim 11 wherein during communications with the remote device, the power control circuit is configured to control the charging circuit to halt charging operations and to provide power from the battery to the one or more wireless interfaces and to control the interface power circuit to provide the power received through the host interface to the baseband and control circuit.

13. The wireless adaptor of claim 11 further comprising a combiner operatively connected to the charging circuit and the interface power circuit, said combiner configured to combine the power received through the host interface with battery power provided by the charging circuit.

14. The wireless adaptor of claim 13 wherein during communications with the remote device, the power control circuit is configured to provide the combined power output by the combiner to the one or more wireless interfaces and to provide the power received through the host interface to the baseband and control circuit when the communication circuit communicates with a remote device.

15. The wireless adaptor of claim 13 wherein the power control circuit is configured to provide the combined power output by the combiner to the baseband and control circuit and the one or more wireless interfaces when the communication circuit communicates with a remote device.

16. A wireless adaptor comprising:
a communication circuit configured to communicate data with a remote device over a wireless network;
a connector configured to receive power from a secondary power source; and
a power control circuit operatively connected to the communication circuit and the connector, said power control circuit configured to provide at least supplemental power from the secondary power source received through the connector to the communication circuit.

17. The wireless adaptor of claim 16 further comprising a host interface configured to communicate data with a host device, and further configured to receive power from the host device.

18. The wireless adaptor of claim 17 wherein the power control circuit comprises:
an interface power circuit configured to control the power received through the host interface to provide power to a baseband and control circuit of the communication circuit; and
a secondary power circuit configured to control the power received through the connector to provide power to one or more wireless interfaces of the communication circuit.

19. The wireless adaptor of claim 17 wherein the power control circuit comprises:
an interface power circuit configured to control the power received through the host interface;
a secondary power circuit configured to control the power received through the connector; and
a combiner operatively connected to the interface power circuit and the secondary power circuit and configured to combine power output by the interface power circuit with power output by the secondary power circuit, wherein said combiner provides the combined power to the communication circuit.

20. The wireless adaptor of claim 17 wherein the power control circuit comprises:
an interface power circuit configured to control the power received through the host interface to provide power to a baseband and control circuit in the communication circuit;
a battery; and
a secondary power circuit operatively connected to the battery and one or more wireless interfaces in the communication circuit, wherein said secondary power circuit is configured to charge the battery with the power received through the connector, and further wherein the secondary power circuit is configured to provide power from the battery to the one or more wireless interfaces.

21. The wireless adaptor of claim 17 wherein the power control circuit comprises:
an interface power circuit configured to control the power received through the host interface;
a secondary power circuit configured to control the power received through the connector;
a battery; and
a joint combiner and charging circuit operatively connected to the interface power circuit, the secondary power circuit, and the battery, said joint combiner and charging circuit configured to:
combine power output by the secondary power circuit with power output by the interface power circuit;
charge the battery with the combined power; and
provide power from the battery to the communication circuit.

22. The wireless adaptor of claim 16 wherein the secondary power source comprises a charger for a host device, and wherein the connector comprises a connector compatible with the charger.

23. The wireless adaptor of claim 16 wherein the secondary power source comprises a power source in a host device and wherein the connector comprises one of a USB interface, an Ethernet interface, and a peripheral interface.

24. The wireless adaptor of claim 16 wherein the secondary power source comprises a charger in a host device docking station, and wherein the connector comprises a power connector in the docking station.

25. A wireless adaptor comprising:
a communication circuit configured to communicate with a remote device over a wireless network;
a host interface connected to a first port of a host device and configured to communicate data with the host device, and further configured to receive power from the host device;
a power control circuit operatively connected to the host interface and the communication circuit, said power control circuit configured to execute a search process to identify a maximum permissible current draw for the power received through the host interface.

26. The wireless adaptor of claim 25 wherein the search process identifies the maximum permissible current draw by:
incrementally increasing a current draw declaration associated with the host interface;
attempting to receive the declared current through the host interface after each incremental increase;
for each attempt, storing operating parameters associated with the host device and a corresponding time stamp; and
identifying the current draw declaration associated with the timestamp immediately preceding a disconnection between the wireless adaptor and the host device as the maximum permissible current draw.

27. The wireless adaptor of claim 25 wherein the power control circuit is further configured to determine one or more wireless communication parameters achievable based on the maximum permissible current draw, and send a communication to the host device to suggest connecting the host interface to an alternate port having a higher permissible current draw to the user of the host device.

28. The wireless adaptor of claim 25 wherein the power control circuit is further configured to:
determine one or more wireless communication parameters achievable based on the maximum permissible current draw;
send the determined communication parameters to the host device; and
control the communication circuit to operate within the determined communication parameters.

29. The wireless adaptor of claim 25 wherein the power control circuit is further configured to:
determine a wireless performance achievable based on the maximum permissible current draw;
send the determined performance to the host device; and
control the communication circuit to achieve the determined performance.
